(19) United States
(12) Patent Application Publication
(10) Pub. No.: US 2010/0182232 A1
(43) Pub. Date: Jul. 22, 2010

(54) Electronic Data Input System

(75) Inventor: Naz Marta Zamoyski, Lawrenceville, NJ (US)

Correspondence Address: Jay M. Brown, 6409 Fayetteville Road, Suite 120-306, Durham, NC, 27713, US

(73) Assignee: Alcatel-Lucent USA Inc., Murray Hill, NJ (US)

(21) Appl. No.: 12/321,545

(22) Filed: Jan. 22, 2009

(51) Int. Cl. G06F 3/033

(52) U.S. Cl. 345/157

(57) ABSTRACT

System including visual display, eye-tracking arrangement, and processor. Eye-tracking arrangement is capable of detecting orientations of an eye toward visual display. Processor is in communication with visual display and with eye-tracking arrangement. Processor is capable of causing cursor to be displayed on visual display. Processor is capable of executing cursor command, from among plurality of cursor commands, in response to detected orientation of an eye toward portion of displayed cursor. Method that includes providing visual display, eye-tracking arrangement, and processor in communication with visual display and with eye-tracking arrangement. Method also includes causing cursor to be displayed on visual display. Method further includes causing orientation of an eye toward portion of displayed cursor to be detected. Method additionally includes causing cursor command from among plurality of cursor commands to be executed in response to detected orientation of an eye. Computer-readable medium.

### BACKGROUND OF THE INVENTION

1. Field of the Invention

This invention generally relates to systems and methods for inputting electronic data.

2. Related Art

This section introduces aspects that may help facilitate a better understanding of the invention. Accordingly, the statements of this section are to be read in this light and are not to be understood as admissions about what is prior art or what is not prior art.

Various types of systems exist for inputting electronic data. Computer data input systems have been developed that utilize a typing keyboard, a computer mouse hardware device, a voice-recognition system, a touch-sensitive screen, an optical character recognition device, an optical scanning device, an Ethernet, USB or other hardwired linkage, a wireless receiver, or a memory device such as a hard drive, flash drive, or tape drive. Despite these developments, there is a continuing need for improved systems for inputting electronic data.

### SUMMARY

In an example of an implementation, a system is provided. The system includes a visual display, an eye-tracking arrangement, and a processor. The eye-tracking arrangement is capable of detecting orientations of an eye toward the visual display. The processor is in communication with the visual display and with the eye-tracking arrangement. The processor is capable of causing a cursor to be displayed on the visual display. The processor is capable of executing a cursor command, from among a plurality of cursor commands, in response to a detected orientation of an eye toward a portion of the displayed cursor.

As another example of an implementation, a method is provided. The method includes providing a visual display, an eye-tracking arrangement, and a processor in communication with the visual display and with the eye-tracking arrangement. The method also includes causing a cursor to be displayed on the visual display. Further, the method includes causing an orientation of an eye toward a portion of the displayed cursor to be detected. In addition, the method includes causing a cursor command to be executed in response to the detected orientation of an eye, from among a plurality of cursor commands.

In a further example of an implementation, a computer-readable medium is provided. The computer readable medium contains computer code for execution by a system including a visual display, an eye-tracking arrangement, and a processor in communication with the visual display and with the eye-tracking arrangement. The computer code is operable to cause the system to perform steps that include causing a cursor to be displayed on the visual display; causing an orientation of an eye toward a portion of the displayed cursor to be detected; and causing a cursor command to be executed in response to the detected orientation of an eye, from among a plurality of cursor commands.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a schematic view showing an example of an implementation of a system.

FIG. 2 is a schematic view showing another example of a system.

FIG. 3 is a schematic view showing a further example of a system.

FIG. 4 is a schematic view showing an additional example of a system.

FIG. 5 is a flow chart showing an example of an implementation of a method.

### DETAILED DESCRIPTION

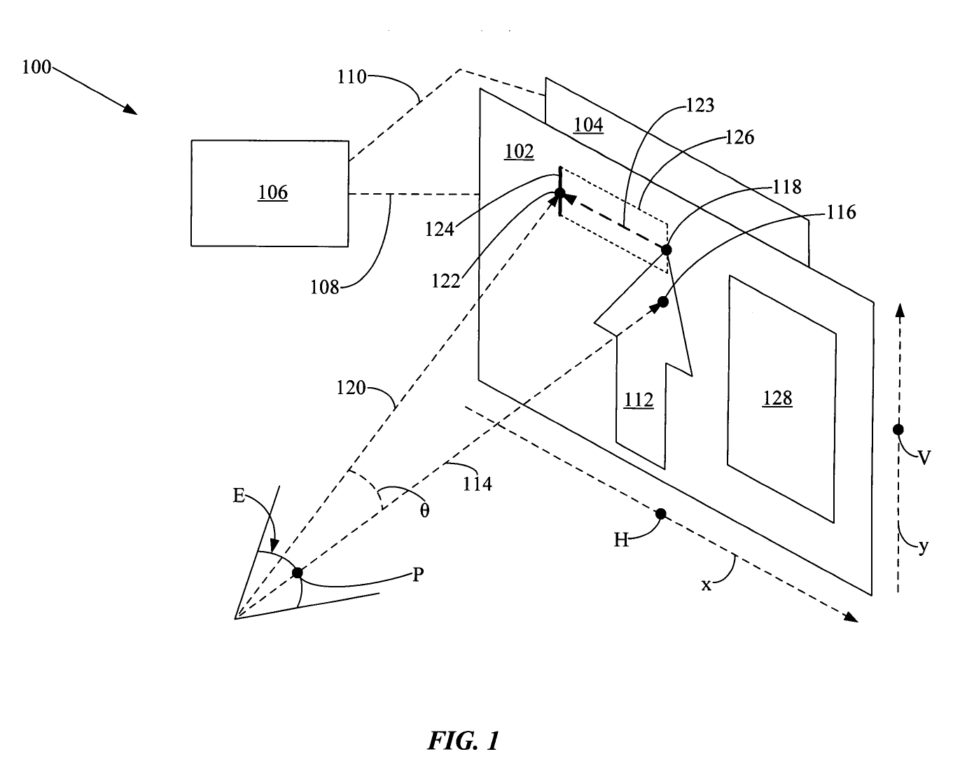

FIG. 1 is a schematic view showing an example of an implementation of a system 100. The system 100 includes a visual display 102, an eye-tracking arrangement 104, and a processor 106. The eye-tracking arrangement 104 is capable of detecting orientations of an eye E toward the visual display 102. The processor 106 is in communication with the visual display 102, as schematically represented by a dashed line 108. The processor 106 is also in communication with the eye-tracking arrangement 104, as schematically represented by a dashed line 110. The processor 106 is capable of causing a cursor 112 to be displayed on the visual display 102. The cursor 112 may be, for example, an on-screen computer mouse cursor. The on-screen computer mouse cursor 112 may serve, for example, a plurality of functions that may include replacing a conventional computer mouse hardware device. The processor 106 is capable of executing a cursor command, from among a plurality of cursor commands (not shown) in response to a detected orientation of an eye E toward a portion of the displayed cursor 112. As an example, a “portion” of a displayed cursor such as the cursor 112 may be a defined region of the cursor, which may include parts of a perimeter of the cursor, or parts of an interior of the cursor, or both. In another example, a “portion” of a displayed cursor such as the cursor 112 may be a point within the cursor, which may be located at the perimeter of the cursor or at the interior of the cursor. As examples, the plurality of cursor commands may include: a mouse cursor pickup command, a point the mouse cursor command, a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, and a cruise-control-off command. The cruise-control-on command may, for example, cause the cursor 112 to move at a predetermined or user-defined rate across the visual display 102, or may cause a data entry field (not shown), such as a Word, Excel, PowerPoint or PDF document also being displayed on the visual display 102, to be vertically or horizontally scrolled on the visual display 102 at a predetermined or user-defined rate. The cursor 112, as well as additional cursors discussed herein, may have any selected shape and appearance. As examples, the cursor 112 may be shaped as an arrow, a vertical line, a cross, a geometric figure, or a real or abstract image or symbol.

In an example of operation of the system 100, a person (not shown) acting as an operator of the system 100 may be suitably located for viewing the visual display 102. The eye E of the system operator may, for example, have an orientation schematically represented by a dashed arrow 1 14. For example, a pupil P of the eye E may gaze at a first point 116 within the cursor 112 as displayed on the visual display 102. The processor 106 may be, in an example, configured to assign two-dimensional pixel coordinates along axes represented by arrows x, y throughout a matrix of pixels (not shown) of the visual display 102. The first point 116 may, as an example, have a horizontal pixel coordinate H along the x axis, and a vertical pixel coordinate V along the y axis. The eye-tracking arrangement 104 is capable of detecting the orientation of the eye E toward the visual display 102. For example, the system 100 may be capable of utilizing data collected by the eye-tracking arrangement 104 in generating point-of-gaze information expressed as pixel coordinates (H,V) representing the first point 116 on the visual display 102 corresponding to the orientation 114 of an eye E.

In another example of operation, the system 100 may cause an arrow tip of the cursor 112 to initially be located at a point 118 on the visual display 102. The cursor 112 may be, for example, an on-screen computer mouse cursor as earlier discussed. Further, for example, the system 100 may initially display the cursor 112 in a “mouse cursor dropped” stationary position on the visual display 102. If the system operator then maintains an orientation 114 of the eye E toward a portion of the cursor 112 or toward the first point 116 within the cursor 112 through a predetermined elapsed time period, the processor 106 may then execute a “mouse cursor pickup” command. Further, for example, the system 100 may subsequently interpret a movement of the eye E to another orientation represented by a dashed arrow 120 toward a second point 122 as a “point the mouse cursor” command. The system 100 may then, for example, cause the arrow tip of the cursor 112 to be moved along a direction of a dashed arrow 123 to the second point 122. If the system operator then maintains an orientation 120 of the eye E toward the second point 122 within the cursor 112 through the predetermined elapsed time period, the processor 106 may then execute a “mouse cursor drop” command. As an additional example, a predetermined eye-blinking motion may be substituted for the predetermined elapsed time period. For example, the system 100 may be configured to detect a slow blinking motion, a rapidly-repeated blinking motion, or another eye-blinking motion as may be predetermined by the system 100 or otherwise defined by the system operator. The predetermined eye-blinking motion may be, as an example, an eye-blinking motion predefined as being substantially different than and distinguishable by the system 100 from a normal eye-blinking motion of the system operator. If the system operator then maintains an orientation 114 of the eye E toward a portion of the cursor 112 or toward the first point 116 within the cursor 112 through the predetermined eye-blinking motion, the processor 106 may then execute a “mouse cursor pickup” command. Further, for example, the system 100 may subsequently interpret a movement of the eye E to another orientation represented by a dashed arrow 120 toward a second point 122 as a “point the mouse cursor” command. The system 100 may then, for example, cause the arrow tip of the cursor 112 to be moved along a direction of a dashed arrow 123 to the second point 122. If the system operator then maintains an orientation 120 of the eye E toward the second point 122 within the cursor 112 through the predetermined eye-blinking motion, the processor 106 may then execute a “mouse cursor drop” command.

If the system operator, as another example, maintains an orientation 114 of the eye E toward a portion of the cursor 112 such as toward the first point 116 within the cursor 112 through a predetermined elapsed time period or through a predetermined eye-blinking motion, the processor 106 may then execute a “mouse click” on a cursor command, from among a plurality of cursor commands (not shown) in response to the detected orientation of the eye E. As examples, the processor 106 may execute a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a cruise-control-on command, or a cruise-control-off command. The system operator may, for example, cause the processor 106 to successively execute a plurality of such cursor commands. In examples, execution of various cursor commands may be confirmed by one or more audible, visible, or vibrational signals. In an example, the cursor 112 may include a portion, such as the point 118, dedicated for execution of “point the mouse cursor” commands by orientation of an eye E toward that point 118 as discussed above. Further, for example, other points or portions (not shown) of the cursor 112 may be dedicated for each of the plurality of other cursor commands by orientations of an eye E toward those points or portions as discussed above.

In an example, the system operator may utilize the system 100 to carry out a text sweeping and selecting operation on a portion 126 of a data entry field, such as a Word, Excel, PDF, or PowerPoint document (not shown) being displayed on the visual display 102. For example, the system operator may cause the processor 106 to successively execute “mouse cursor pickup” and “point the mouse cursor” cursor commands as earlier discussed, placing the arrow tip of the cursor 112 at the point 118, being a selected position on the portion 126 of the data entry field for starting the text sweeping operation. Next, for example, the system operator may cause the processor 106 to successively execute “single mouse left click” and “drag cursor left” cursor commands utilizing the on-screen computer mouse cursor 112. The system operator may then, as an example, move the eye E to an orientation 120 toward the second point 122. Next, for example, the system operator may execute a “mouse cursor drag-drop” or “mouse cursor drop” cursor command. At that point, for example, text in the portion 126 of the data entry field between the points 118 and 122 may be designated by the processor 106 as “selected”.

Next, the system operator may cause the processor 106 to generate a copy of the selected text for a subsequent text pasting operation. For example, the system operator may execute a “single mouse right click command” by an orientation of the eye E toward a point or portion of the cursor 112. The single mouse right click command may, for example, cause a right mouse command menu 128 to be displayed on the visual display 102. Next, for example, the system operator may move the eye E to an orientation toward a “copy” command (not shown) on the right mouse command menu 128, and then execute a “single mouse left click” command as earlier discussed. At that point, for example, text in the portion 126 of the data entry field between the points 118 and 122 may be designated by the processor 106 as “copied”.

The system operator may, as another example, utilize the system 100 to cause the processor 106 to carry out a dragging operation on a scroll bar having a scroll button (not shown) on the visual display 102. First, for example, the system operator may utilize the system 100 to carry out a “point the mouse cursor” command, moving the cursor 112 to the scroll button. Next, the system operator may for example utilize the system 100 to cause the processor 106 to carry out a “drag cursor down”, “drag cursor up”, “drag cursor left” or “drag cursor right” cursor command as appropriate. In another example, the system operator may utilize the system 100 to cause the processor 106 to scroll through a data entry field (not shown) displayed on the visual display 102, such as a Word, Excel, PDF, or PowerPoint document. First, for example, the system operator may utilize the system 100 to carry out a “point the mouse cursor” command, moving the cursor 112 to a selected position on the data entry field. Next, the system operator may for example utilize the system 100 to cause the processor 106 to carry out a “drag cursor down”, “drag cursor up”, “drag cursor left” or “drag cursor right” cursor command to scroll the data entry field in an appropriate direction. Next, for example, the system operator may execute a “mouse cursor drag-drop” or “mouse cursor drop” cursor command.

The system 100 may, as another example, be configured for utilizing an orientation of an eye E with respect to the visual display 102 in activating and deactivating the system 100, that is, in turning the system 100 “on” and “off”. For example, the eye-tracking arrangement 104 may be capable of detecting an absence of an orientation of an eye E toward the visual display 102. As an example, if the system operator averts both of his or her eyes E away from the visual display 102 through a predetermined elapsed time period, the system 100 may then cause the processor 106 to deactivate or “turn off” the system 100. Subsequently, for example, if the system operator then maintains an orientation of an eye E toward the visual display 102 through a predetermined elapsed time period, the system 100 may then cause the processor 106 to activate or “turn on” the system 100. The eye-tracking arrangement 104 may, for example, remain in operation while other portions of the system 100 are deactivated, to facilitate such re-activation of the system 100. As an example, a predetermined elapsed time period for so “turning off” the system 100 may be a relatively long time period, so that the system operator may temporarily avert his or her eyes E from the visual display 102 in a natural manner without prematurely “turning off” the system 100. In further examples, the system 100 may be configured to utilize other orientations of an eye E toward the visual display 102 in analogous ways to activate or deactivate the system 100. For example, the system 100 may be configured to utilize predetermined eye-blinking motions toward the visual display 102 in analogous ways to activate or deactivate the system 100.

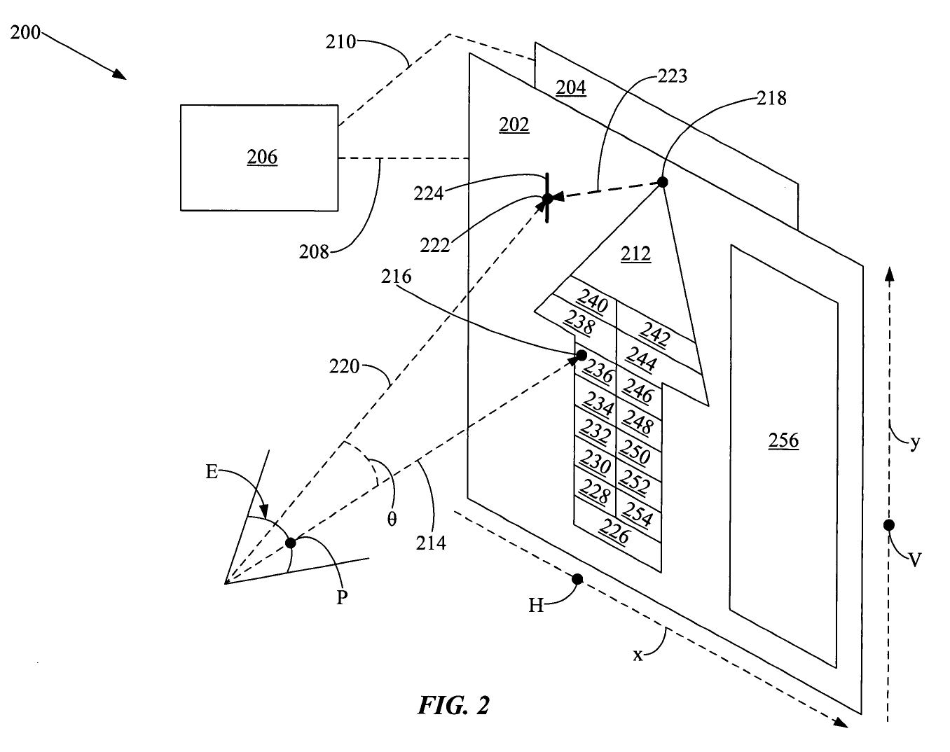

FIG. 2 is a schematic view showing another example of a system 200. The system 200 includes a visual display 202, an eye-tracking arrangement 204, and a processor 206. The eye-tracking arrangement 204 is capable of detecting orientations of an eye E toward the visual display 202. The processor 206 is in communication with the visual display 202, as schematically represented by a dashed line 208. The processor 206 is also in communication with the eye-tracking arrangement 204, as schematically represented by a dashed line 210. The processor 206 is capable of causing a cursor 212 to be displayed on the visual display 202. In an example, the cursor 212 may include a portion, such as the point 218, dedicated for execution of “point the mouse cursor” commands by orientation of an eye E toward that point 218 in the same manner as discussed above in connection with the system 100. The processor 206 may, for example, be configured to cause the displayed cursor 212 to include a plurality of cursor command actuators 226, 228, 230, 232, 234, 236, 238, 240, 242, 244, 246, 248, 250, 252, 254, each displayed at a different portion of the visual display 202, wherein each of the cursor command actuators 226-254 corresponds to one of the cursor commands (not shown). For example, the cursor command actuators 226, 228, 230, 232, 234, 236, 238, 240, 242, 244, 246, 248, 250, 252, 254 may respectively correspond to the following cursor commands: a mouse cursor pickup command, a point the mouse cursor command, a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a mouse cursor drop command, a mouse cursor drag-drop command, and a cruise-control on/off toggle command. Each of the cursor command actuators 226-254 may for example include a label (not shown) identifying its corresponding cursor command. As examples, each of such labels (not shown) may always be visible on the cursor 212, or may be hidden except when the eye E has a detected orientation 214 toward a first point 216 within a portion of the cursor 212 including a corresponding one of the cursor command actuators 226-254. The processor 206 is capable of executing a cursor command, from among a plurality of cursor commands (not shown) in response to a detected orientation of an eye E toward a point or portion of the cursor 212 such as one of the plurality of cursor command actuators 226-254 within the displayed cursor 212.

In an example of operation of the system 200, a person (not shown) acting as an operator of the system 200 may be suitably located for viewing the visual display 202. The eye E of the system operator may, for example, have an orientation schematically represented by a dashed arrow 214. For example, a pupil P of the eye E may gaze at a first point 216 within the cursor 212 as displayed on the visual display 202. The processor 206 may, in an example, be configured to assign two-dimensional pixel coordinates along axes represented by arrows x, y throughout a matrix of pixels (not shown) of the visual display 202. The first point 216 may, as an example, have a horizontal pixel coordinate H along the x axis, and a vertical pixel coordinate V along the y axis. The eye-tracking arrangement 204 is capable of detecting the orientation of the eye E toward the visual display 202. For example, the system 200 may be capable of utilizing data collected by the eye-tracking arrangement 204 in generating point-of-gaze information expressed as pixel coordinates (H,V) representing the first point 216 within the cursor 212 on visual display 202 corresponding to the orientation of an eye 214. The first point 216 on the visual display 202 may be, for example, located within one of the plurality of cursor command actuators 226-254 each displayed at a different portion of the cursor 212, wherein each of the cursor command actuators 226-254 corresponds to one of the cursor commands (not shown). The processor 206 may, as an example, be capable of executing a cursor command, selected from among a plurality of cursor commands (not shown), corresponding to the one of the plurality of cursor command actuators 226-254. In the example as shown in FIG. 2, the processor 206 may execute a “show mouse cursor menu” command in response to the detected orientation 214 of an eye E toward the first point 216 on the cursor command actuator 236 representing a “show mouse cursor menu” command within the displayed cursor 212. In an example, the processor 206 may then cause the visual display 202 to display a mouse cursor menu 256 including a plurality of labels (not shown) identifying the cursor commands respectively corresponding to the cursor command actuators 226-254. As another example, each of the cursor command actuators 226-254 may for example include a label (not shown) identifying its corresponding cursor command. As another example, each of such labels (not shown) may be hidden except when the eye E has a detected orientation 214 toward a first point 216 within one of the cursor command actuators 226-254. As another example, each of the cursor command actuators 226-254 may be color-coded to identify its corresponding cursor command.

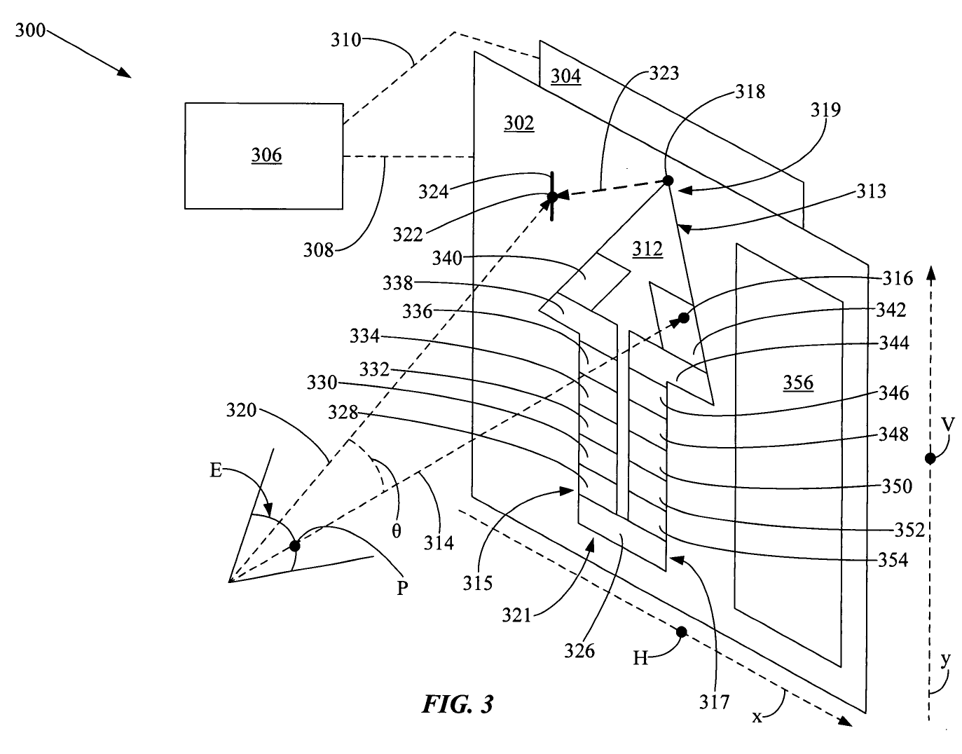

FIG. 3 is a schematic view showing a further example of a system 300. The system 300 includes a visual display 302, an eye-tracking arrangement 304, and a processor 306. The eye-tracking arrangement 304 is capable of detecting orientations of an eye E toward the visual display 302. The processor 306 is in communication with the visual display 302, as schematically represented by a dashed line 308. The processor 306 is also in communication with the eye-tracking arrangement 304, as schematically represented by a dashed line 310. The processor 306 is capable of causing a cursor 312 to be displayed on the visual display 302. The cursor 312 may, in an example, have a perimeter 313. In an example, the cursor 312 may include a portion, such as the point 318, dedicated for execution of “point the mouse cursor” commands by orientation of an eye E toward that point 318 in the same manner as discussed above in connection with the system 100. The cursor 312 may, for example, include a plurality of cursor command actuators 326, 328, 330, 332, 334, 336, 338, 340, 342, 344, 346, 348, 350, 352, 354 each displayed at a different portion of the perimeter 313 of the cursor 312 on the visual display 302, wherein each of the cursor command actuators 326-354 corresponds to one of the cursor commands (not shown). For example, the cursor command actuators 326, 328, 330, 332, 334, 336, 338, 340, 342, 344, 346, 348, 350, 352, 354 may respectively correspond to the following cursor commands: a mouse cursor pickup command, a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, and a cruise-control-off command. The processor 306 is capable of executing a cursor command, from among a plurality of cursor commands (not shown) in response to a detected orientation of an eye E toward a point or portion of the cursor 312 such as one of the plurality of cursor command actuators 326-354 around the perimeter 313 of the displayed cursor 312.

Each of the cursor command actuators 326-354 may for example include a label (not shown) identifying its corresponding cursor command. As an example, each of such labels (not shown) may be hidden except when the eye E has a detected orientation 314 toward a first point 316 along a portion of the perimeter 313 of the cursor 312 including a corresponding one of the cursor command actuators 326-354. In a further example, execution of the “show mouse cursor menu” command may cause the processor 306 to display a mouse cursor menu 356. As another example, each of the cursor command actuators 326-354 may be color-coded to identify its corresponding cursor command. In a further example, each of the plurality of cursor command actuators 326-354 may be located at a portion of the perimeter 313 of the cursor 312 selected such that the location is suitable for indicating the corresponding cursor command. For example, each of the plurality of cursor command actuators 326-354 may be located at a portion of the perimeter 313 of the cursor 312 in a manner consistent with the layout of manual cursor command actuators in a conventional computer mouse hardware device. For example, “left” and “right” command actuators may respectively be located at a left side 315 and a right side 317 of the perimeter 313. Further for example, a “double click” command may be located adjacent to its corresponding “single click” command. Additionally for example, “up” and “down” commands may respectively be located at a top end 319 and a bottom end 321 of the perimeter 313.

In an example of operation of the system 300, a person (not shown) acting as an operator of the system 300 may be suitably located for viewing the visual display 302. The eye E of the system operator may, for example, have an orientation schematically represented by a dashed arrow 314. For example, a pupil P of the eye E may gaze at a first point 316 on the perimeter 313 of the cursor 312 as displayed on the visual display 302. The processor 306 may, in an example, be configured to assign two-dimensional pixel coordinates along axes represented by arrows x, y throughout a matrix of pixels (not shown) of the visual display 302. The first point 316 may, as an example, have a horizontal pixel coordinate H along the x axis, and a vertical pixel coordinate V along the y axis. The eye-tracking arrangement 304 is capable of detecting the orientation of the eye E toward the visual display 302. For example, the system 300 may be capable of utilizing data collected by the eye-tracking arrangement 304 in generating point-of-gaze information expressed as pixel coordinates (H,V) representing the first point 316 on the perimeter 313 of the cursor 312 on visual display 302 corresponding to the orientation 314 of an eye E. The first point 316 on the visual display 302 may be, for example, located on one of the plurality of cursor command actuators 326-354 each displayed at a different portion of the perimeter 313 of the cursor 312, wherein each of the cursor command actuators 326-354 corresponds to one of the cursor commands (not shown). The processor 306 may, as an example, be capable of executing a cursor command, selected from among a plurality of cursor commands (not shown), corresponding to the one of the plurality of cursor command actuators 326-354. In the example as shown in FIG. 3, the processor 306 may execute a “single mouse right click” command in response to the detected orientation 314 of an eye E toward the first point 316 on the cursor command actuator 342 representing a “single mouse right click” command, on the perimeter 313 of the displayed cursor 312.

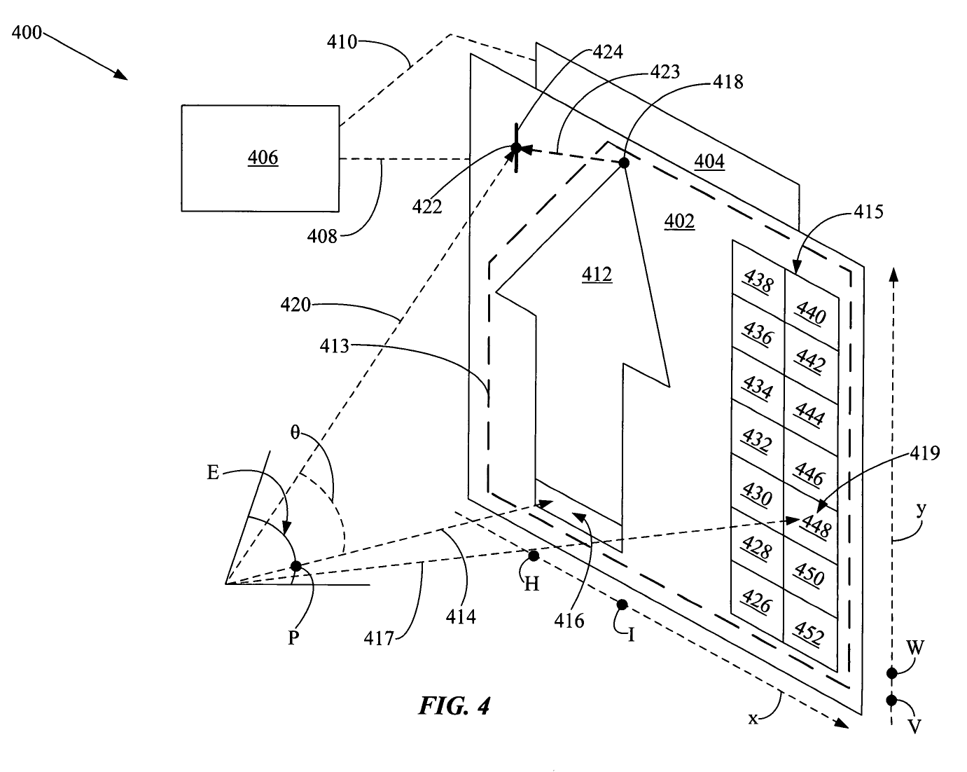

FIG. 4 is a schematic view showing an additional example of a system 400. The system 400 includes a visual display 402, an eye-tracking arrangement 404, and a processor 406. The eye-tracking arrangement 404 is capable of detecting orientations of an eye E toward the visual display 402. The processor 406 is in communication with the visual display 402, as schematically represented by a dashed line 408. The processor 406 is also in communication with the eye-tracking arrangement 404, as schematically represented by a dashed line 410. The processor 406 is capable of causing a cursor 412 to be displayed on the visual display 402. As an example, the processor 406 may be capable of causing the visual display 402 to display, in response to a detected orientation of an eye E toward a point or portion of the cursor 412, an expanded cursor 413 including the cursor 412 and also including a mouse cursor menu 415 having a plurality of cursor command actuators 426, 428, 430, 432, 434, 436, 438, 440, 442, 444, 446, 448, 450, 452 each corresponding to one of the plurality of cursor commands. For example, the cursor command actuators 426, 428, 430, 432, 434, 436, 438, 440, 442, 444, 446, 448, 450, 452 may respectively correspond to the following cursor commands: a mouse cursor pickup command, a drag cursor left command, a double mouse left click command, a single mouse left click command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, and a cruise-control-off command. For example, the menu 415 of cursor command actuators 426-452 may be hidden from view on the visual display 402 except when the eye E has a detected orientation 414 toward the cursor 412. As another example, the menu 415 of cursor command actuators 426-452 may be hidden from view on the visual display 402 except when the eye E has a detected orientation 414 toward a first portion 416 of the cursor 412. As examples, the first portion 416 of the cursor 412 may be marked by having a different appearance than other portions of the cursor 412, such as by a designated color or shading. Further, for example, the menu 415 of cursor command actuators 426-452 may be displayed on the visual display 402 adjacent to the cursor 412, or at another location (not shown) on the visual display 402. The processor 406 is capable of executing a cursor command, from among a plurality of cursor commands (not shown) in response to a detected orientation of an eye E toward one of the plurality of cursor command actuators 426-452 as displayed on the visual display 402, when the system 400 detects an orientation of an eye E toward a portion of the cursor 412, or toward a portion of the expanded cursor 413.

In an example of operation of the system 400, a person (not shown) acting as an operator of the system 400 may be suitably located for viewing the visual display 402. The eye E of the system operator may, for example, have an orientation schematically represented by a dashed arrow 414. For example, a pupil P of the eye E may gaze at a first portion 416 of the cursor 412 as displayed on the visual display 402. The processor 406 may, in an example, be configured to assign two-dimensional pixel coordinates along axes represented by arrows x, y throughout a matrix of pixels (not shown) of the visual display 402. The first portion 416 may, as an example, have a range of horizontal pixel coordinates H through I along the x axis, and a range of vertical pixel coordinates V through W along the y axis. The eye-tracking arrangement 404 is capable of detecting the orientation of the eye E toward the visual display 402. For example, the system 400 may be capable of utilizing data collected by the eye-tracking arrangement 404 in generating point-of-gaze information expressed as a matrix range of pixel coordinates (H,V) through (I,W) representing the first portion 416, within the cursor 412 on visual display 402 corresponding to the orientation 414 of an eye E. When the system 400 detects that the eye E has an orientation 414 toward the first portion 416 of the cursor 412, the processor 406 may then, for example, cause the expanded cursor 413 including the menu 415 of cursor command actuators 426-452 to be displayed on the visual display 402, with the menu 415 being adjacent to the cursor 412 or at another location on the visual display 402. The system operator (not shown) may then, for example, cause the eye E to have an orientation 417 toward a second portion 419 of the expanded cursor 413, including one of the cursor command actuators 426-452 in the displayed menu 415. The processor 406 may then, as an example, execute a cursor command, selected from among a plurality of cursor commands (not shown), corresponding to the one of the plurality of cursor command actuators 426-452. In the example as shown in FIG. 4, the processor 406 may execute a “mouse cursor drag-drop” command in response to the detected orientation 417 of an eye E toward a second portion 419 of the menu 415 including the cursor command actuator 448 representing a “mouse cursor drag-drop” command.

A system 100, 200, 300, 400 may be, for example, capable of detecting a time duration of an orientation 114, 214, 314, 414, 417 of an eye E that is being maintained toward the point or portion 116, 216, 316, 416, 419 of the cursor 112, 212, 312, 412 on the visual display 102, 202, 302, 402. For example, the eye-tracking arrangement 104, 204, 304, 404 may continuously sample point-of-gaze data as to orientations of an eye E toward the visual display 102, 202, 302, 402 and as either being toward the cursor 112, 212, 312, 412 or being toward another portion of the visual display 102, 202, 302, 402, or being away from the visual display 102, 202, 302, 402. Further, for example, the processor 106, 206, 306, 406 may be capable of comparing a predetermined time period value to the detected time duration of the orientation 114, 214, 314, 414, 417 of an eye E toward the point or portion 116, 216, 316, 416, 419 on the visual display 102, 202, 302, 402. The processor 106, 206, 306, 406 may then, for example, be capable of executing a cursor command when the detected time duration reaches the predetermined time period value. The predetermined time period value may be, for example, a system operator—defined time period, programmed into the system 100, 200, 300, 400. The system 100, 200, 300, 400 may also, for example, store a plurality of different predetermined time period values having different corresponding functions. As an example, a shortest predetermined time period value may be defined and stored by the processor 106, 206, 306, 406 for each of the “mouse cursor pickup” and “mouse cursor drop” commands. The system 100, 200, 300, 400 may, as another example, store a predetermined time period value for “turning on” the system 100, 200, 300, 400; and a predetermined time period value for “turning off” the system 100, 200, 300, 400.

A system 100, 200, 300, 400 may further be, for example, capable of detecting an initial position of the eye E at an orientation 114, 214, 314, 414, toward a first point or portion 116, 216, 316, 416 of the visual display 102, 202, 302, 402. The system 100, 200, 300, 400 may, in that further example, then be capable of detecting movement of the eye E to a subsequent position at another orientation schematically represented by a dashed arrow 120, 220, 320, 420 toward a second point or portion 122, 222, 322, 422 of the visual display 102, 202, 302, 402. As another example, a processor 106, 206, 306, 406 may be capable of causing the cursor 112, 212, 312, 412 to be moved across the visual display 102, 202, 302, 402, in response to detection of movement of an eye E from an orientation 114, 214, 314, 414 being toward a first point or portion 116, 216, 316, 416 of the visual display 102, 202, 302, 402, to another orientation 120, 220, 320, 420 of the eye E being toward a second point or portion 122, 222, 322, 422 of the visual display 102, 202, 302, 402. Further, as an example, the processor 106, 206, 306, 406 may be capable of causing the visual display 102, 202, 302, 402 to display a data field input cursor 124, 224, 324, 424, and the processor 106, 206, 306, 406 may be capable of causing the data field input cursor 124, 224, 324, 424 to be moved along a direction of a dashed arrow 123, 223, 323, 423 to the second point or portion 122, 222, 322, 422 of the visual display 102, 202, 302, 402. A system 100, 200, 300, 400 may additionally, for example, be capable of detecting a change in an orientation 114, 214, 314, 414 of an eye E by more than a threshold angle theta (θ). In an example of operation, the system 100, 200, 300, 400 may, once a change in an orientation 114, 214, 314, 414 of an eye E by more than a threshold angle θ is detected, cause the processor 106, 206, 306, 406 to move the cursor 112, 212, 312, 412 across the visual display 102, 202, 302, 402 in a direction and along a proportional distance corresponding to the direction and magnitude of the change in the orientation 114, 214, 314, 414 of an eye E relative to the visual display 102, 202, 302, 402.

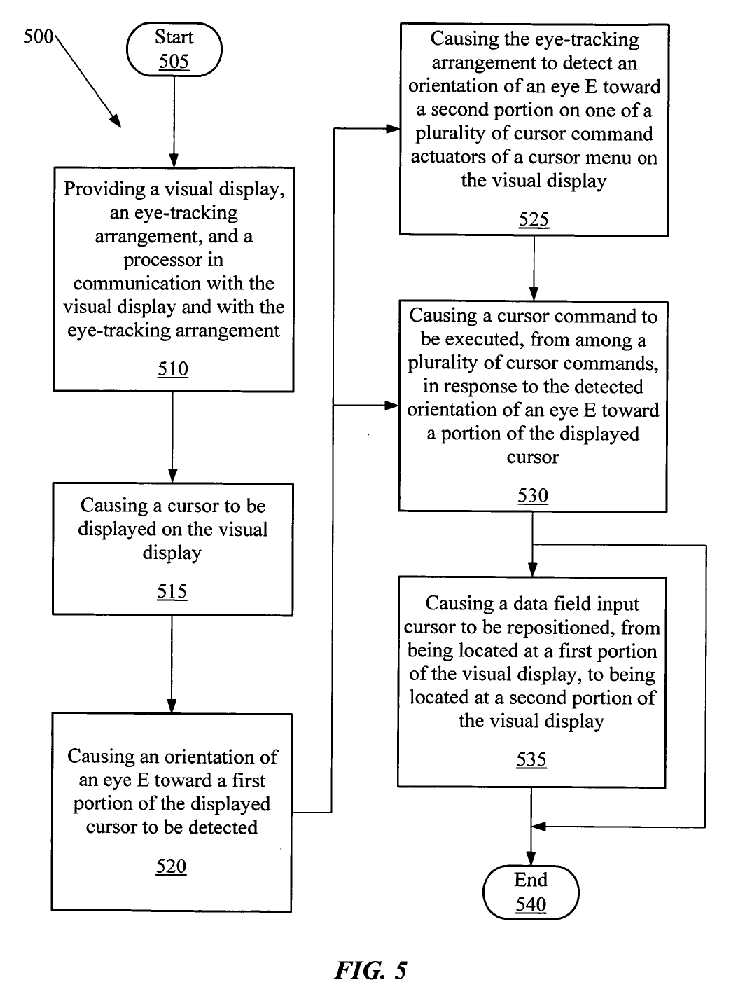

FIG. 5 is a flow chart showing an example of an implementation of a method 500. The method starts at step 505, and then step 510 includes providing a visual display 102, 202, 302, 402, an eye-tracking arrangement 104, 204, 304, 404, and a processor 106, 206, 306, 406 in communication with the visual display 102, 202, 302, 402 and with the eye-tracking arrangement 104, 204, 304, 404. Step 510 may include, in examples, configuring the processor 106, 206, 306, 406 to assign two-dimensional pixel coordinates along axes represented by arrows x, y throughout a matrix of pixels (not shown) of the visual display 102, 202, 302, 402. Step 515 includes causing a cursor 112, 212, 312, 412 to be displayed on the visual display 102, 202, 302, 402.

In an example, a system operator (not shown) may be suitably located for viewing the visual display 102, 202, 302, 402. The eye E of the system operator may, for example, have an orientation schematically represented by a dashed arrow 114, 214, 314, 414. A pupil P of the eye E may be gazing at a first point or portion 116, 216, 316, 416 of the cursor 112, 212, 312, 412 on the visual display 102, 202, 302, 402. The first point or portion 116, 216, 316, 416 may, as an example, include a point-of-gaze having a horizontal pixel coordinate H along the x axis, and a vertical pixel coordinate V along the y axis. At step 520, an orientation of the eye E may be detected toward a first point or portion 116, 216, 316, 416 of the cursor 112, 212, 312, 412 on the visual display 102, 202, 302, 402. For example, the eye-tracking arrangement 104, 204, 304, 404 may be caused to detect the orientation of the eye E. Further at step 520 for example, data may be collected by the eye-tracking arrangement 104, 204, 304, 404; and the data may be utilized in generating point-of-gaze information expressed as pixel coordinates (H,V) representing the first point or portion 116, 216, 316, 416 on the visual display 102, 202, 302, 402 corresponding to the orientation 114, 214, 314, 414 of the eye E.

In step 530, a cursor command is executed, from among a plurality of cursor commands (not shown) in response to the detected orientation of the eye E toward a point or portion of the displayed cursor 112, 212, 312, 412. For example, the processor 106, 206, 306, 406 may execute the cursor command. As examples, the plurality of cursor commands may include: a mouse cursor pickup command, a point the mouse cursor command, a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, and a cruise-control-off command. The method 500 may then, for example, end at step 540.

In another example, step 515 may include causing a cursor 212 to be displayed on the visual display 202, the cursor 212 including a plurality of cursor command actuators 226, 228, 230, 232, 234, 236, 238, 240, 242, 244, 246, 248, 250, 252, 254 each being displayed at a different portion of the visual display 202, wherein each of the cursor command actuators 226-254 corresponds to one of the cursor commands (not shown). Further in that example, step 515 may include programming the processor 206 so that the cursor command actuators 226, 228, 230, 232, 234, 236, 238, 240, 242, 244, 246, 248, 250, 252, 254 may respectively correspond to the following cursor commands: a mouse cursor pickup command, a point the mouse cursor command, a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, and a cruise-control-off command. Also, for example, step 515 may include programming the processor 206 to cause the visual display 202 to display each of the cursor command actuators 226-254 in a manner suitable to identify their corresponding cursor commands. As an example, step 515 may include programming the processor 206 to cause the visual display 202 to display labels identifying the cursor command corresponding to each of the cursor command actuators 226-254. As an example, step 515 may include programming the processor 206 to always display such labels on the cursor 212. As another example, step 515 may include programming the processor 206 to hide such labels except when an eye E has a detected orientation 214 toward a first point or portion 216 of the cursor 212 including a corresponding one of the cursor command actuators 226-254. Further, for example, step 530 may include causing the processor 206 to execute a cursor command, from among a plurality of cursor commands (not shown), in response to a detected orientation of an eye E toward one of the plurality of cursor command actuators 226-254 of the displayed cursor 212.

As another example, step 515 may include causing a cursor 312 having a cursor perimeter 313 to be displayed on the visual display 302, the cursor 312 including a plurality of cursor command actuators 326, 328, 330, 332, 334, 336, 338, 340, 342, 344, 346, 348, 350, 352, 354 each displayed at a different portion of the perimeter 313 of the cursor 312 on visual display 302, wherein each of the cursor command actuators 326-354 corresponds to one of the cursor commands (not shown). Additionally in that example, step 515 may include programming the processor 306 so that the cursor command actuators 326, 328, 330, 332, 334, 336, 338, 340, 342, 344, 346, 348, 350, 352, 354 may respectively correspond to the following cursor commands: a mouse cursor pickup command, a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, and a cruise-control-off command. Further, for example, step 515 may include programming the processor 306 to cause the visual display 302 to display each of the cursor command actuators 326-354 in a manner suitable to identify their corresponding cursor commands. As an example, step 515 may include programming the processor 306 to cause the visual display 302 to display labels identifying the cursor command corresponding to each of the cursor command actuators 326-354. As another example, step 515 may include programming the processor 306 to hide such labels except when an eye E has a detected orientation 314 toward a first point 316 at a portion of the perimeter 313 of the cursor 312 including a corresponding one of the cursor command actuators 326-354. As another example, step 515 may include programming the processor 306 to cause each of the cursor command actuators 326-354 to be displayed on the visual display 302 as color-coded to identify its corresponding cursor command. In a further example, step 515 may include programming the processor 306 to cause each of the plurality of cursor command actuators 326-354 to be displayed on the visual display 302 at a location on a portion of the perimeter 313 of the cursor 312 selected such that the location is suitable for indicating the corresponding cursor command. For example, “left” and “right” command actuators may respectively be located at a left side 315 and a right side 317 of the perimeter 313. Further for example, a “double click” command may be located adjacent to its corresponding “single click” command. Additionally for example, “up” and “down” commands may respectively be located at a top end 319 and a bottom end 321 of the perimeter 313. Further, for example, step 530 may include causing the processor 306 to execute a cursor command, from among a plurality of cursor commands (not shown), in response to a detected orientation of an eye E toward one of the plurality of cursor command actuators 326-354 around the perimeter 313 of the displayed cursor 312.

In an additional example, step 515 may include programming the processor 406 to be capable of displaying a cursor 412, and to be capable of additionally displaying, in response to a detected orientation of an eye E toward a portion of the cursor 412, a menu 415 including a plurality of cursor command actuators 426, 428, 430, 432, 434, 436, 438, 440, 442, 444, 446, 448, 450, 452 each corresponding to one of the plurality of cursor commands. Further in that example, step 515 may include causing a cursor 412 to be displayed on the visual display 402 such that the menu 415 is initially not displayed, and is hidden. Step 515 may further include, for example, detecting when an eye E has an orientation 414 toward the cursor 412, and then displaying, on the visual display 402, the menu 415 including the plurality of cursor command actuators 426-452. Step 515 may include, as another example, detecting when an eye E has an orientation 414 toward a first portion 416 of the cursor 412, and then displaying, on the visual display 402, the menu 415 including the plurality of cursor command actuators 426-452. As examples, step 515 may include displaying the first portion 416 of the cursor 412 as marked by having a different appearance than other portions of the cursor 412, such as by a designated color or shading. Further, for example, step 515 may include displaying the menu 415 of cursor command actuators 426-452 either on the visual display 402 adjacent to the cursor 412, or at another location (not shown) on the visual display 402. For example, step 515 may include programming the processor 406 so that the cursor command actuators 426, 428, 430, 432, 434, 436, 438, 440, 442, 444, 446, 448, 450, 452 may respectively correspond to the following cursor commands: a mouse cursor pickup command, a drag cursor left command, a double mouse left click command, a single mouse left click command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, and a cruise-control-off command. At step 520, the eye-tracking arrangement 404 may be caused to detect an orientation of an eye E toward a first point or portion 416 of the cursor 412 on the visual display 402. At step 525, the eye-tracking arrangement 404 may be caused to detect an orientation of an eye E toward a second point or portion 419 on one of the plurality of cursor command actuators 426-452 of the cursor menu 415 on the visual display 402. Further, for example, step 530 may include causing the processor 406 to execute the cursor command, from among a plurality of cursor commands (not shown), in response to a detected orientation of an eye E toward one of the plurality of cursor command actuators 426-452 within the displayed cursor 412.

In an example, steps 520, 525 may include detecting a time duration of an orientation 114, 214, 314, 414 of an eye E being maintained toward the first point or portion 116, 216, 316, 416 of the cursor 112, 212, 312, 412 of the visual display 102, 202, 302, 402. Further, for example, steps 520, 525 may include comparing a predetermined time period value to the detected time duration of the orientation 114, 214, 314, 414 of an eye E toward the first point or portion 116, 216, 316, 416 on the visual display 102, 202, 302, 402. Additionally in that example, step 530 may include causing the processor 106, 206, 306, 406 to execute a cursor command when the detected time duration reaches the predetermined time period value. Step 510 may also include, for example, programming the predetermined time period value into the processor 106, 206, 306, 406 as a system operator—defined time period.

In an example, steps 520, 525 may include detecting an initial position of the eye E at an orientation in the direction of a dashed arrow 114, 214, 314, 414, being toward a first point or portion 116, 216, 316, 416 of the visual display 102, 202, 302, 402. Further in that example, steps 520, 525 may include detecting movement of the eye E to a subsequent position at another orientation in a direction of a dashed arrow 120, 220, 320, 420 being toward a second point 122, 222, 322, 422 of the visual display 102, 202, 302, 402. Additionally in that example, the method 500 may include, at step 530, moving the cursor 112, 212, 312, 412 across the visual display 102, 202, 302, 402, in response to detection of movement of an eye E from an orientation toward a first point or portion 116, 216, 316, 416 of the visual display 102, 202, 302, 402, to another orientation toward a second point 122, 222, 322, 422 of the visual display 102, 202, 302, 402. For example, an arrow tip of the cursor 112, 212, 312, 412 may thus be moved on the visual display 102, 202, 302, 402 from a first point 118, 218, 318, 418 to a second point 122, 222, 322, 422. Additionally in that example, the method 500 may include displaying a data field input cursor 124, 224, 324, 424 at step 515; and at step 535, causing the data field input cursor 124, 224, 324, 424 of the processor 106, 206, 306, 406 to be repositioned from being located at the first point or portion 118, 218, 318, 418 to being located at the second point or portion 122, 222, 322, 422.

In another example, step 520, 525 may include detecting a change in an orientation 114, 214, 314, 414 of an eye E toward the visual display 102, 202, 302, 402, by more than a threshold angle θ. Further in that example, the method 500 may include, at step 530, then causing the processor 106, 206, 306, 406 to move the cursor 112, 212, 312, 412 across the visual display 102, 202, 302, 402 in a direction, and along a distance, corresponding to the direction and proportional to the magnitude of the change in the orientation 114, 214, 314, 414 of an eye relative to the visual display 102, 202, 302, 402.

The visual display 102, 202, 302, 402 selected for inclusion in a system 100, 200, 300, 400 may be implemented by, for example, any monitor device suitable for utilization as a graphical user interface, such as a liquid crystal display (“LCD”), a plasma display, a light projection device, or a cathode ray tube. A system 100, 200, 300, 400 may include one or a plurality of visual displays 102, 202, 302, 402.

The eye-tracking arrangement 104, 204, 304, 404 selected for inclusion in a system 100, 200, 300, 400 may be implemented by, for example, an eye-tracking arrangement selected as being capable of detecting an orientation 114, 214, 314, 414 of an eye E toward a visual display 102, 202, 302, 402. For example, the eye-tracking arrangement 104, 204, 304, 404 may include (not shown) one or more cameras. Further, as an example, the cameras (not shown) may be mounted on the visual display 102, 202, 302, 402. The eye-tracking arrangement 104, 204, 304, 404 may, for example, generate point-of-gaze information expressed as (H,V) coordinates for locations of a person's eye E pupils P toward the visual display 102, 202, 302, 402. The system 100, 200, 300, 400 may, for example, utilize the (H,V) coordinate data to set a location of the cursor 112, 212, 312, 412 on the visual display 102, 202, 302, 402. The eye-tracking arrangement 104, 204, 304, 404 may be calibrated, for example, by focusing the camera(s) on the pupil(s) P of the person's eye(s) E and by having the person remain still while looking at a series of points at different spaced-apart locations having known coordinates (H,V) throughout the visual display 102, 202, 302, 404. The eye-tracking arrangement 104, 204, 304, 404 may be utilized in programming the processor 106, 206, 306, 406 as to predetermined elapsed time periods or predetermined eye-blinking motions as earlier discussed. For example, the time period(s) for converting an orientation of an E toward a point or portion of the visual display 102, 202, 302, 402 into a “mouse click” command for causing the processor 106, 206, 306, 406 to carry out an operation in the system 100, 200, 300, 400 may be set by prompting the person to maintain an orientation 114, 214, 314, 414 of an eye E for a user-defined length of time which may then be stored by the processor 106, 206, 306, 406 as a predetermined elapsed time period. As another example, the predetermined eye-blinking motion(s) for converting an orientation of an E toward a point or portion of the visual display 102, 202, 302, 402 into a “mouse click” command or for causing the processor 106, 206, 306, 406 to carry out another operation in the system 100, 200, 300, 400 may be set by prompting the person to maintain an orientation 114, 214, 314, 414 of an eye E through a user-defined eye-blinking motion which may then be stored by the processor 106, 206, 306, 406 as a predetermined eye-blinking motion for causing a defined operation of the system 100, 200, 300, 400 to be executed.

In another example, the eye-tracking arrangement 104, 204, 304, 404 may include (not shown): a head-mounted optics apparatus, a camera, a reflective monocle, and a controller. For example, a camera including a charge-coupled device may be utilized. The processor 106, 206, 306, 406 may function as a controller for the eye-tracking arrangement 104, 204, 304, 404, or a separate controller (not shown) may be provided. The head-mounted optics apparatus may, for example, include a headband similar to the internal support structure that may be found inside a football or bicycle helmet. The camera may, for example, have a near infrared illuminator. As an example, a small camera may be selected and mounted on the headband suitably positioned to be above a person's eye E when the headband is worn. The monocle, having dimensions for example of about three inches by two inches, may be positioned to lie below an eye E of a person wearing the headband. As an example, the eye-tracking arrangement 104, 204, 304, 404 may also include a magnetic head tracking unit (not shown). The magnetic head tracking unit may, for example, include a magnetic transmitter, a gimbaled pointing device, and a sensor. In an example, the magnetic transmitter and the gimbaled pointing device may be placed on a fixed support directly behind the location of a person's head when the eye-tracking arrangement 104, 204, 304, 404 is in use; and a small sensor may be placed on the headband. In operation of the eye-tracking arrangement 104, 204, 304, 404, the eye E of the person may be illuminated by the near infrared beam on the headband. An image of the eye E may then be reflected in the monocle. The camera may then, for example, receive the reflected image and transmit that image to the processor 106, 206, 306, 406. Further, for example, the magnetic head tracking unit may send head location (x,y) coordinate data to the processor 106, 206, 306, 406. The processor 106, 206, 306, 406 may then integrate data received from the camera and from the magnetic head tracking unit into (H,V) point-of-gaze coordinate data. Precise calibration of a person's point-of-gaze may depend upon, as examples, the distances from the visual display 102, 202, 302, 402 to the person's eyes E and to the magnetic head tracking unit. Such an eye-tracking arrangement 104, 204, 304, 404 may be commercially available, for example, from Applied Science Laboratories, Bedford, Mass. USA, under the trade designation CU4000 or SU4000.

In a further example, an eye-tracking arrangement 104, 204, 304, 404 may include (not shown), a headband on which one or a plurality of cameras may be mounted. For example, two cameras may be positioned on the headband to be located below the eyes E of a person wearing the headband. In that example, eye tracking (x,y) coordinate data may be recorded for both the left and right eyes E of the person. In an example, the two cameras may collect eye tracking data at a sampling rate within a range of between about 60 Hertz (“Hz”) and about 250 Hz. A third camera, for example, may be positioned on the headband to be located at approximately the middle of the forehead of a person while wearing the headband. As an example, the orientation of the third camera may be detected by infrared sensors placed on the visual display 102, 202, 302, 402. Further, for example, the third camera may record movements of the person's head relative to the visual display 102, 202, 302, 402. As an example, the eye-tracking arrangement 104, 204, 304, 404 may be calibrated by focusing each of the cameras on the pupil(s) P of the person's eye(s) E and by having the person remain still while looking at a series of points at different spaced-apart locations having known coordinates (H,V) throughout the visual display 102, 202, 302, 402. Such an eye-tracking arrangement 104, 204, 304, 404 may be commercially available, for example, from Sensor/Motorics Instrumentation (SMI), Germany) under the trade name “EyeLink System”.

It is understood that other eye-tracking arrangements 104, 204, 304, 404 may be utilized. For example, an eye-tracking arrangement 104, 204, 304, 404 may be configured to function by inferring orientations of an eye E from physiological measurements of electropotentials on the surface of the skin proximate to a person's eye E. Additional eye-tracking arrangements 104, 204, 304, 404 may be commercially available, as a further example, from EyeTracking, Inc., 6475 Alvarado Road, Suite 132, San Diego, Calif. 92120 USA. A system 100, 200, 300, 400 may include one or a plurality of eye-tracking arrangements 104, 204, 304, 404. Further background information regarding eye-tracking arrangements 104, 204, 304, 404 is included in the following documents, the entireties of all of which hereby are incorporated by reference into the discussions herein regarding each of the systems 100, 200, 300, 400, and regarding the method 500: Marshall U.S. Pat. No. 6,090,051 issued on Jul. 18, 2000; Edwards U.S. Pat. No. 6,102,870 issued on Aug. 15, 2000; and Marshall Patent Publication No. 2007/0291232A1 published on Dec. 20, 2007.

The processor 106, 206, 306, 406 selected for inclusion in a system 100, 200, 300, 400 may be, for example, any electronic processor suitable for receiving data from the eye-tracking arrangement 104, 204, 304, 404 and for controlling the visual display 102, 202, 302, 402. The processor 106, 206, 306, 406 may also be selected, for example, as suitable for controlling operations of the eye-tracking arrangement 104, 204, 304, 404. It is understood that one or more functions or method steps described in connection with the systems 100, 200, 300, 400 and the method 500 may be performed by a processor 106, 206, 306, 406 implemented in hardware and/or software. Additionally, steps of the method 500 may be implemented completely in software executed within a processor 106, 206, 306, 406. Further, for example, the processor 106, 206, 306, 406 may execute algorithms suitable for configuring the systems 100, 200, 300, 400 or the method 500. Examples of processors 106, 206, 306, 406 include: a microprocessor, a general purpose processor, a digital signal processor, or an application-specific digital integrated circuit. The processor 106, 206, 306, 406 may also include, for example, additional components such as an active memory device, a hard drive, a bus, and an input/output interface. For example, the visual display 102, 202, 302, 402 and the processor 106, 206, 306, 406 for a system 100, 200, 300, 400 may be collectively implemented by a personal computer. If the method 500 is performed by software, the software may reside in software memory (not shown) and/or in the processor 106, 206, 306, 406 used to execute the software. The software in a software memory may include an ordered listing of executable instructions for implementing logical functions, and may be embodied in any digital machine-readable and/or computer-readable medium for use by or in connection with an instruction execution system, such as a processor-containing system. A system 100, 200, 300, 400 may include one or a plurality of processors 106, 206, 306, 406.

In a further example of an implementation, a computer-readable medium (not shown) is provided. The computer readable medium contains computer code for execution by a system 100, 200, 300, 400 including a visual display 102, 202, 302, 402, an eye-tracking arrangement 104, 204, 304, 404, and a processor 106, 206, 306, 406 in communication with the visual display 102, 202, 302, 402 and with the eye-tracking arrangement 104, 204, 304, 404. The computer code is operable to cause the system 100, 200, 300, 400 to perform steps of the method 500 including: causing a cursor 112, 212, 312, 412 to be displayed on the visual display 102, 202, 302, 402; causing an orientation of an eye E toward a portion of the displayed cursor 112, 212, 312, 412 to be detected; and causing a cursor command to be executed in response to the detected orientation of an eye E, from among a plurality of cursor commands. In further examples, the computer readable medium may contain computer code that, when executed by a system 100, 200, 300, 400, may carry out other variations of the method 500 as earlier discussed. Examples of computer-readable media include the following: an electrical connection (electronic) having one or more wires; a portable computer diskette (magnetic); a random access memory (RAM, electronic); a read-only memory “ROM” (electronic); an erasable programmable read-only memory (EPROM or Flash memory) (electronic); an optical fiber (optical); and a portable compact disc read-only memory “CDROM” “DVD” (optical). The computer-readable medium may be, as further examples, paper or another suitable medium upon which the program is printed, as the program may be electronically captured, via, for instance, optical scanning of the paper or other medium, then compiled, interpreted or otherwise processed in a suitable manner if necessary, and then stored in a computer memory.

The system 100, 200, 300, 400 may be utilized, for example, in replacement of a conventional computer mouse hardware device. In that example, the system 100, 200, 300, 400 generates an on-screen computer mouse cursor 112, 212, 312, 412 on the visual display 102, 202, 302, 402. The system 100, 200, 300, 400 may, as an example, utilize the same hardware interface and software interface as are utilized with a conventional computer mouse hardware device. The system 100, 200, 300, 400 may, for example, facilitate hands-free control of an on-screen computer mouse cursor 112, 212, 312, 412 on a visual display 102, 202, 302, 402. Such hands-free control of an on-screen computer mouse cursor 112, 212, 312, 412 may be useful to persons, as examples, who are handicapped, or who seek to avoid repetitive motion injuries of their hands and arms, or who are engaged in an activity where hands-free control of the cursor 112, 212, 312, 412 may otherwise be useful. Further, for example, such hands-free control of an on-screen computer mouse cursor 112, 212, 312, 412 may be faster or otherwise more efficient than use of a conventional computer mouse hardware device. The system 100, 200, 300, 400 may also be utilized, as examples, together with a hands-free keyboard or together with a conventional computer mouse hardware device. In further examples, the system 100, 200, 300, 400 may be utilized in partial or selective functional replacement of a conventional computer mouse hardware device. For example, the system 100, 200, 300, 400 may be utilized for some operations capable of being performed by a conventional computer mouse hardware device or keyboard, while other operations may be performed by such a conventional computer mouse hardware device or keyboard. The method 500 and the computer readable media may be, for example, implemented in manners analogous to those discussed in connection with the systems 100, 200, 300, 400. It is understood that each of the features of the various examples of systems 100, 200, 300, 400 may be included in or excluded from a particular system 100, 200, 300, 400 as selected for a given end-use application, consistent with the teachings herein as to each and all of the systems 100, 200, 300, 400. It is understood that the various examples of the systems 100, 200, 300, 400 illustrate analogous examples of variations of the method 500, and the entire discussions of all of the systems 100, 200, 300, 400 are accordingly deemed incorporated into the discussion of the method 500 and of the computer readable media. Likewise, it is understood that the various examples of the method 500 illustrate analogous examples of variations of the systems 100, 200, 300, 400 and of the computer readable medium provided herein, and the entire discussion of the method 500 is accordingly deemed incorporated into the discussion of the systems 100, 200, 300, 400 and into the discussion of such computer readable medium.

Moreover, it will be understood that the foregoing description of numerous examples has been presented for purposes of illustration and description. This description is not exhaustive and does not limit the claimed invention to the precise forms disclosed. Modifications and variations are possible in light of the above description or may be acquired from practicing the invention. The claims and their equivalents define the scope of the invention.

What is claimed is:

1. A system, comprising:
a visual display;
an eye-tracking arrangement capable of detecting orientations of an eye toward the visual display; and
a processor in communication with the visual display and with the eye-tracking arrangement;
wherein the processor is capable of causing a cursor to be displayed on the visual display; and
wherein the processor is capable of executing a cursor command, from among a plurality of cursor commands, in response to a detected orientation of an eye toward a portion of the displayed cursor.

2. The system of claim 1, wherein the processor is configured to cause the cursor to include a displayed cursor command actuator corresponding to a cursor command being a member of a group consisting of: a mouse cursor pickup command, a point the mouse cursor command, a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, a cruise-control-off command, and a combination including two or more of the foregoing.

3. The system of claim 1, wherein the processor is configured to cause the cursor to include a plurality of cursor command actuators each displayed at a different portion of the visual display, wherein each cursor command actuator corresponds to one of the cursor commands.

4. The system of claim 1, wherein the processor is configured to cause the cursor to have a displayed perimeter, and wherein each of the plurality of cursor command actuators is displayed at a different portion of the perimeter.

5. The system of claim 1, wherein the processor is configured to cause an expanded cursor to be displayed in response to a detected orientation of an eye toward a portion of the cursor, the expanded cursor including the cursor and displaying a mouse cursor menu having a plurality of cursor command actuators each corresponding to one of the plurality of cursor commands.

6. The system of claim 1 wherein the processor is capable of causing the cursor to be moved on the visual display, in response to detection of movement of an eye from having an orientation toward a first portion of the visual display, to having another orientation of the eye toward a second portion of the visual display.

7. The system of claim 6, wherein the processor is capable of causing the visual display to display a data field input cursor, and wherein the processor is capable of causing the data field input cursor to be moved to the second portion of the visual display.

8. The system of claim 1, wherein the processor is capable of comparing a predetermined time period value to a detected time duration of the orientation of an eye toward the portion of the visual display, and wherein the processor is capable of executing the cursor command when the detected time duration reaches the predetermined time period value.

9. A method, comprising:
providing a visual display, an eye-tracking arrangement, and a processor in communication with the visual display and with the eye-tracking arrangement;
causing a cursor to be displayed on the visual display;
causing an orientation of an eye toward a portion of the displayed cursor to be detected; and
causing a cursor command to be executed in response to the detected orientation of an eye, from among a plurality of cursor commands.

10. The method of claim 9, wherein causing the cursor to be displayed includes displaying on the visual display a cursor command actuator corresponding to a cursor command being a member of a group consisting of: a mouse cursor pickup command, a point the mouse cursor command, a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, a cruise-control-off command, and a combination including two or more of the foregoing.

11. The method of claim 9, wherein causing the cursor to be displayed includes displaying each of a plurality of cursor command actuators at a different portion of the visual display, wherein each cursor command actuator corresponds to one of the cursor commands.

12. The method of claim 9, wherein causing the cursor to be displayed includes displaying on the visual display a cursor perimeter, and wherein each of the plurality of cursor command actuators is displayed at a different portion of the perimeter.

13. The method of claim 9, wherein causing the cursor to be displayed includes displaying on the visual display, in response to a detected orientation of an eye toward a portion of the cursor, a menu including a plurality of cursor command actuators each corresponding to one of the plurality of cursor commands.

14. The method of claim 9, wherein the method includes moving the cursor from a first portion of the visual display to a second portion of the visual display, in response to detection of movement of an eye from a first orientation toward the first portion, to a second orientation toward the second portion.

15. The method of claim 14, wherein the method includes displaying a data field input cursor on the visual display, and moving the data field input cursor from the first portion to the second portion.

16. A computer-readable medium, the computer readable medium containing computer code that, when executed by a system including a visual display, an eye-tracking arrangement, and a processor in communication with the visual display and with the eye-tracking arrangement, is operable to cause the system to perform steps comprising:
causing a cursor to be displayed on the visual display;
causing an orientation of an eye toward a portion of the displayed cursor to be detected; and
causing a cursor command to be executed in response to the detected orientation of an eye, from among a plurality of cursor commands.

17. The computer-readable medium of claim 16, further containing computer code that is operable to cause the system to perform steps that include displaying on the visual display a cursor command actuator corresponding to a cursor command being a member of a group consisting of: a mouse cursor pickup command, a point the mouse cursor command, a drag cursor left command, a double mouse left click command, a single mouse left click command, a show mouse cursor menu command, a drag cursor up command, a drag cursor down command, a hide mouse cursor menu command, a single mouse right click command, a double mouse right click command, a drag cursor right command, a mouse cursor drop command, a mouse cursor drag-drop command, a cruise-control-on command, a cruise-control-off command, and a combination including two or more of the foregoing.

18. The computer-readable medium of claim 16, further containing computer code that is operable to cause the system to perform steps that include displaying each of a plurality of cursor command actuators at a different portion of the visual display, wherein each cursor command actuator corresponds to one of the cursor commands.

19. The computer-readable medium of claim 16, further containing computer code that is operable to cause the system to perform steps that include displaying on the visual display a cursor perimeter, and wherein each of the plurality of cursor command actuators is displayed at a different portion of the perimeter.

20. The computer-readable medium of claim 16, further containing computer code that is operable to cause the system to perform steps that include displaying on the visual display, in response to a detected orientation of an eye toward a portion of the cursor, a menu including a plurality of cursor command actuators each corresponding to one of the plurality of cursor commands.

21. The computer-readable medium of claim 16, further containing computer code that is operable to cause the system to perform steps that include moving the cursor from a first portion of the visual display to a second portion of the visual display, in response to detection of movement of an eye from a first orientation toward the first portion, to a second orientation toward the second portion.

22. The computer-readable medium of claim 21, further containing computer code that is operable to cause the system to perform steps that include displaying a data field input cursor on the visual display, and moving the data field input cursor from the first portion to the second portion.
